(19) United States
(12) Patent Application Publication
(10) Pub. No.: US 2024/0246078 A1
(43) Pub. Date: Jul. 25, 2024

(54) MATERIAL TRANSFER DEVICE AND METHOD

(71) Applicant: Scientific Bridge LLC, Columbus, OH (US)

(72) Inventors: Binbin Deng, Columbus, OH (US); Claire Shen, Columbus, OH (US); Feng Shen, Columbus, OH (US)

(21) Appl. No.: 18/158,562

(22) Filed: Jan. 24, 2023

(51) Int. Cl. B01L 3/00

(52) U.S. Cl. CPC B01L 3/508; B01L 2200/141; B01L 2300/04; B01L 2300/08

(57) ABSTRACT

A material transfer device includes a shell assembly and a core. The shell assembly has a chamber and an opening. The opening is in communication with the chamber. The core is arranged in the chamber and includes a material holder. The shell assembly and the core are configured to rotate relative to each other to seal the material holder inside the chamber or expose the material holder via the opening.

### FIELD OF THE TECHNOLOGY

This application relates to the field of material preparation and transfer and, more particularly, to a material transfer device and a material transfer method.

### BACKGROUND OF THE DISCLOSURE

Nowadays, various instruments (e.g., electron microscopes, such as scanning electron microscope (SEM) and transmission electron microscope (TEM), dual-beam focused ion beam (FIB) system, precision ion milling/polishing system, nanoindentation system, atomic force microscope, etc.) are widely used in material preparation and characterization. A sample of a material to be used in an instrument is often prepared in a protected environment, such as a glovebox, and is then transferred to the instrument for subsequent operation, such as being transferred to a microscope for analysis. Since the sample can be air-sensitive, the sample needs to be protected from being exposed to the air during the transfer.

To better meet requirements for material transfer between instruments, a material transfer device with relatively low cost and high compatibility is required.

### SUMMARY

In accordance with the disclosure, there is provided a material transfer device, including a shell assembly and a core. The shell assembly has a chamber and an opening. The opening is in communication with the chamber. The core is arranged in the chamber and includes a material holder. The shell assembly and the core are configured to rotate relative to each other to seal the material holder inside the chamber or expose the material holder via the opening.

Also in accordance with the disclosure, there is provided a material transfer method. The method includes rotating a core of a material transfer device to cause a material holder to be exposed to an outside environment, the material transfer device being in an operation mode, rotating the core to cause the material holder to be in a chamber of a shell assembly of the material transfer device, the material transfer device being in a sealed mode, transferring the material transfer device to a target location, and rotating the core to cause the material holder to be exposed through an opening of the material transfer device.

### BRIEF DESCRIPTION OF THE DRAWINGS

FIG. 1 is a schematic structural diagram of a material transfer device according to an embodiment of the disclosure.

FIG. 2A is a schematic structural diagram of a first shell of a material transfer device according to an embodiment of the disclosure.

FIG. 2B is a schematic structural diagram of a first shell of a material transfer device according to an embodiment of the disclosure

FIG. 3A is a schematic structural diagram of a second shell of a material transfer device according to an embodiment of the disclosure.

FIG. 3B is a schematic structural diagram of a second shell of a material transfer device according to an embodiment of the disclosure.

FIG. 4 is a schematic diagram showing a core arranged on a second shell of a material transfer device according to an embodiment of the disclosure.

FIG. 5 is a schematic structural diagram of a core of a material transfer device according to an embodiment of the disclosure.

FIG. 6A is a schematic diagram showing a core of a material transfer device in an operation mode and a sealed mode according to an embodiment of the disclosure.

FIG. 6B is a schematic diagram showing a core of a material transfer device in an operation mode and a sealed mode according to an embodiment of the disclosure.

FIG. 7 is a schematic diagram of a material transfer device with a rotatable shell assembly according to an embodiment of the disclosure.

FIG. 8 is a schematic flowchart of a material transfer method according to an embodiment of the present disclosure.

### DESCRIPTION OF EMBODIMENTS

The following describes the technical solutions in the embodiments of the present disclosure with reference to the accompanying drawings. Wherever possible, the same reference numbers will be used throughout the drawings to refer to the same or like parts. The described embodiments are merely some but not all of the embodiments of the present disclosure. Other embodiments obtained by a person skilled in the art based on the embodiments of the present disclosure without creative efforts shall fall within the scope of the present disclosure.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “vertical,” “horizontal,” “perpendicular,” “left,” “right,” and similar expressions used herein, are merely intended for purposes of description. The term “and/or” used herein includes any suitable combination of one or more related items listed.

In this disclosure, a value or a range of values may refer to a desired, target, or nominal value or range of values and can include slight variations. The term “about” or “approximately” associated with a value can allow a variation within, for example, 10% of the value, such as ±2%, ±5%, or ±10% of the value, or another proper variation as appreciated by one of ordinary skill in the art. The term “about” or “approximately” associated with a state can allow a slight deviation from the state. For example, a first component being approximately perpendicular to a second component can indicate that the first component is either exactly perpendicular to the second component or slightly deviates from being perpendicular to the second component, and an angle between the first and second components can be within a range from, e.g., 80° to 100°, or another proper range as appreciated by one of ordinary skill in the art.

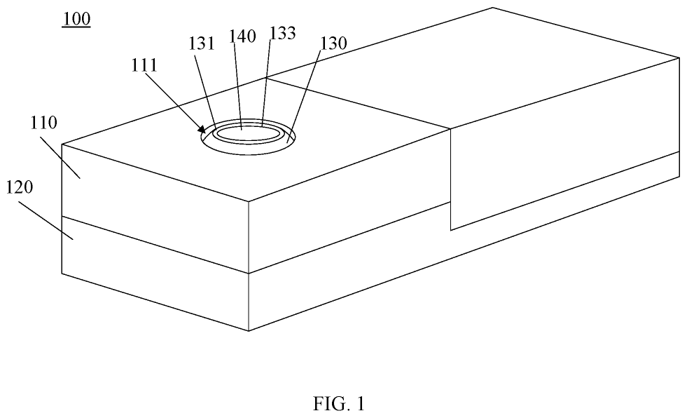

FIG. 1 is a schematic structural diagram of an example material transfer device 100 according to an embodiment of the disclosure. As shown in FIG. 1, the material transfer device 100 includes a shell assembly, which includes a first shell 110 and a second shell 120, and a core 130. The shell assembly can have a chamber formed by the first shell 110 and the second shell 120, and an opening 111 in communication with the chamber. The chamber is configured to accommodate the core 130. In the example shown in FIG. 1, the opening 111 is formed on an upper surface of the shell assembly, i.e., an upper surface of the first shell 110 in FIG. 1. In some other embodiments, the opening 111 can be formed at another surface of the shell assembly, such as a side surface the shell assembly (a side surface of the first shell 110 and/or a side surface of the second shell 120 in FIG. 1) or a bottom surface of the shell assembly (a bottom surface of the second shell 120 in FIG. 1).

As described above, the shell assembly of the material transfer device 100 includes the first shell 110 and the second shell 120 that can be attached to each other. In the example shown in FIG. 1, the first shell 110 is arranged over the second shell 120, and hence the first shell 110 and the second shell 120 can also be referred to as “upper shell” and “lower shell,” respectively. In some other embodiments, the first shell 110 and the second shell 120 can be arranged in a different positional relation, such as a left-right relation or a front-rear relation. Hereinafter, the first shell 110 and the second shell 120 being in the up-down relation will be described as an example.

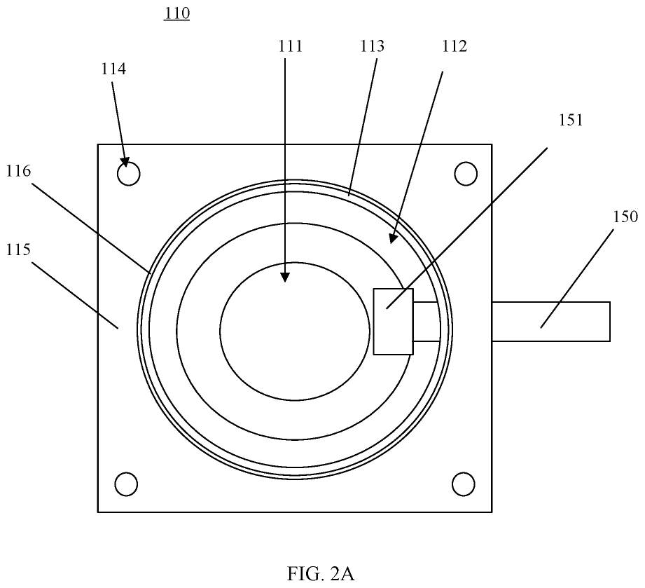

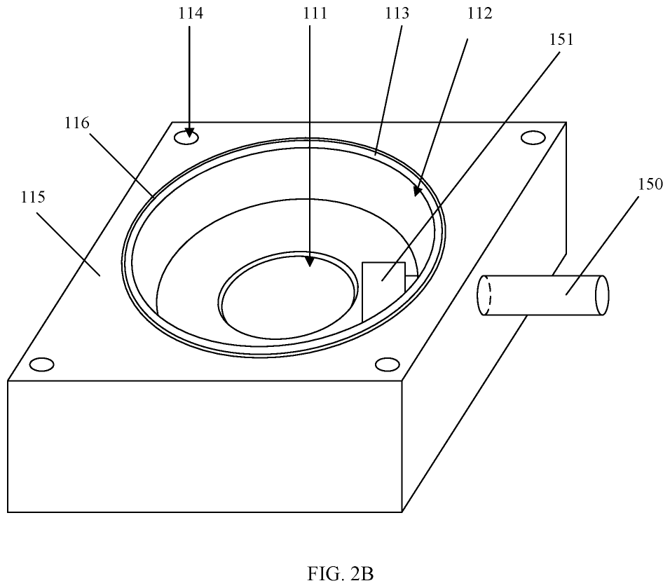

FIGS. 2A and 2B are schematic structural diagrams showing an example of the first shell 110 of the material transfer device 100 according to an embodiment of the disclosure. FIG. 2A is a plan view and FIG. 2B is a perspective view. As shown in FIGS. 2A and 2B, the opening 111 is formed at the first shell 110. Further, a first chamber space 112 is formed in the first shell 110. The first chamber space 112 can be configured to accommodate at least a portion of the core 130.

As shown in FIGS. 2A and 2B, the first shell 110 further includes a flange 115 extending outwards from a periphery of the first chamber space 112. The flange 115 can abut against the second shell 120 such that the first shell 110 is attached to the second shell 120. In the example shown in FIGS. 2A and 2B, the flange 115 surrounds the first chamber space 112.

As shown in FIG. 2B, the first shell 110 further includes a through-hole formed at a side of the first shell 110. The material transfer device 100 further includes a rotation shaft 150 arranged through the through-hole. In some embodiments, a sealing member (such as an elastic ring, e.g., rubber ring) can be arranged at least partially between the rotation shaft 150 and an inner surface of the through-hole, to prevent leakage from occurring through the space between the rotation shaft 150 and the inner surface of the through-hole. The rotation shaft 150 includes a connection member 151 (such as a connection head) for connecting to the core 130. The rotation shaft 150 can rotate the core 130, for example, under the actuation of a drive mechanism.

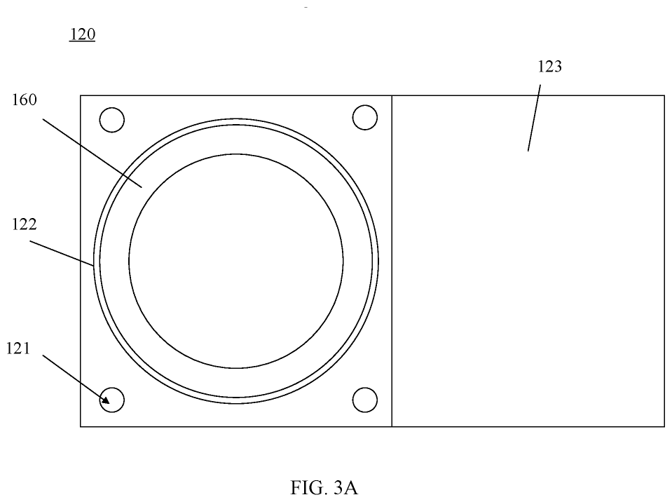

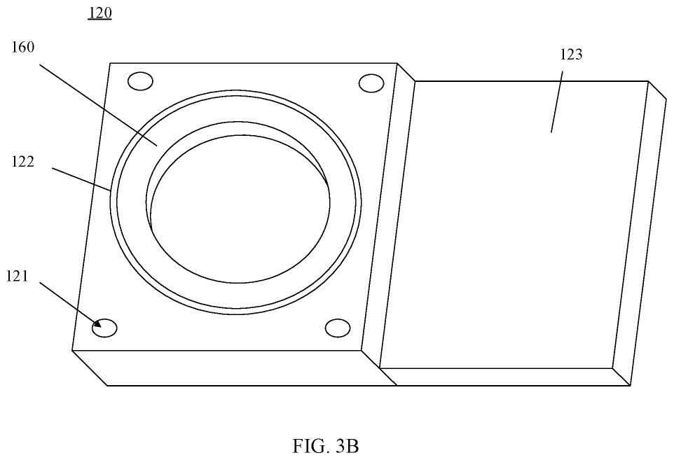

FIGS. 3A and 3B are schematic structural diagrams showing an example of the second shell 120 of the material transfer device 100 according to an embodiment of the disclosure. FIG. 3A is a plan view and FIG. 3B is a perspective view. As shown in FIGS. 3A and 3B, a second chamber space 122 is formed in the second shell 120, and the second chamber space 122 is configured to accommodate at least a portion of the core 130. In some embodiments, as shown in FIGS. 3A and 3B, the material transfer device 100 further includes an extension plate 123 at a side of the second shell 120. The extension plate 123 can serve as a base for mounting other components of the material transfer device 100, such as the drive mechanism that drives the rotation shaft 150 to rotate the core 130. The extension plate 123 can be formed integrally with the shell assembly (e.g., the second shell 120), or fixedly connected to the shell assembly (e.g., the second shell 120) in a suitable manner.

Refer to FIGS. 2A and 2B again, the first shell 110 further includes a protrusion 113 protruding from the flange 115, e.g., at a side of the flange 115 facing the second shell 120, along a periphery of the first chamber space 112. In some embodiments, the protrusion 113 of the first shell 110 can cooperate with an inner surface of the second chamber space 122 of the second shell 120 to form a sealed connection between the first shell 110 and the second shell 120. In some other embodiments, an O-ring can be arranged around the protrusion 113 to further ensure an air-tight connection between the first shell 110 and the second shell 120. In some embodiments, as shown in FIGS. 2A and 2B, a circular groove 116 is formed surrounding the protrusion 113, and the O-ring can be partially arranged in the groove 116.

Further, the first shell 110 also includes a plurality of through-holes 114 on the flange 115. Similarly, as shown in FIGS. 3A and 3B, the second shell 120 also includes a plurality of holes 121 each corresponding to one of the plurality of through-holes 114 of the first shell 110. For example, the plurality of through-holes 114 of the first shell 110 can be aligned with the plurality of holes 121 of the second shell. In some embodiments, the plurality of through-holes 114 and the plurality of holes 121 can be threaded holes. In some other embodiments, the plurality of through-holes 114 can be non-threaded through holes. The first shell 110 and the second shell 120 can be connected to each other by screws or bolts passing through the plurality of through-holes 114 and connected to the plurality of holes 121. In some other embodiments, the first shell 110 and the second shell 120 can be connected to each other in another manner or formed as an integral structure.

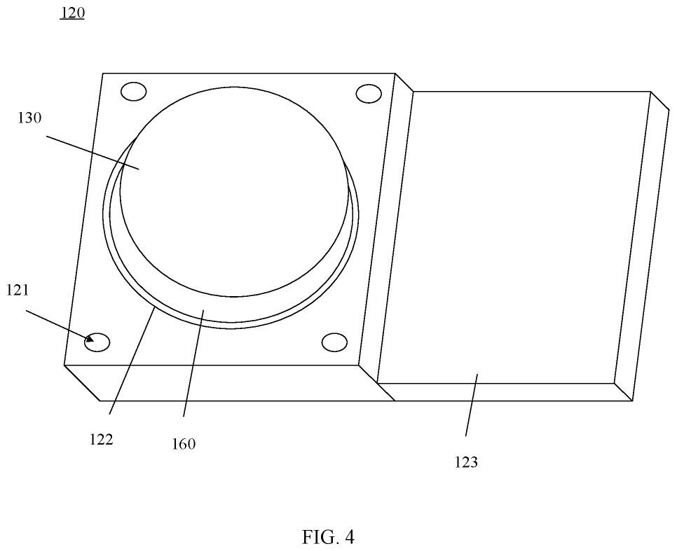

Refer to FIGS. 3A and 3B again, the material transfer device 100 further includes a seal member 160 arranged in the second chamber space 122. FIG. 4 is a schematic diagram showing the core 130 placed at the second shell 120 of the material transfer device 100 according to an embodiment of the disclosure. As shown in FIGS. 3A, 3B, and 4, the seal member 160 cooperates with the inner surface of the second chamber space 122 and the curved surface of the core 130 to form a sealed space between a bottom surface of the second shell 120 and the core 130.

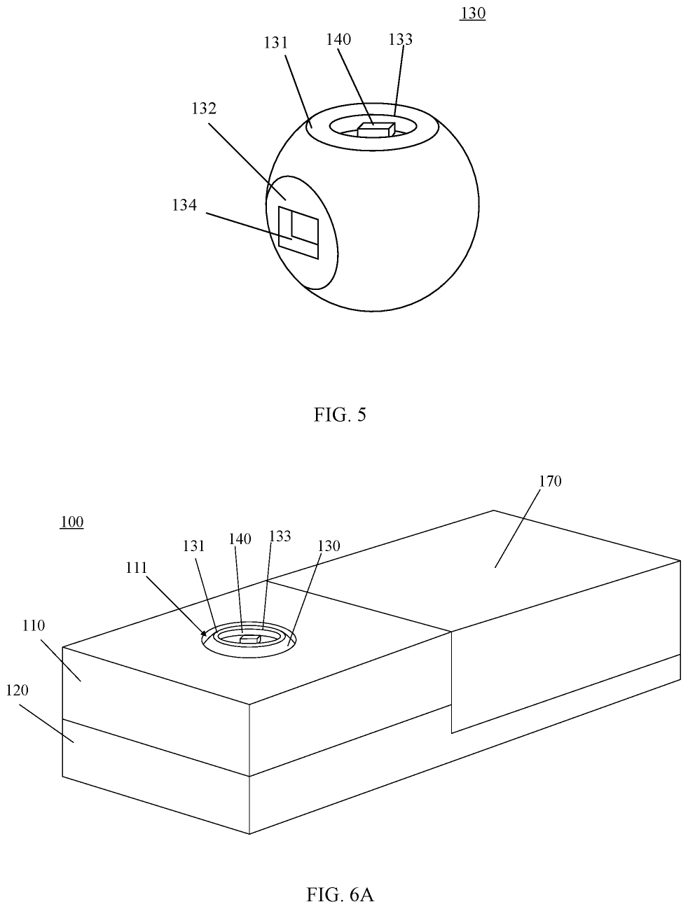

FIG. 5 is a schematic structural diagram of the core 130 of the material transfer device 100 according to an embodiment of the disclosure. As shown in FIGS. 1 and 5, the core 130 has a curved surface. The core 130 can have an overall shape that allows it to rotate relative to the shell assembly to be oriented in various directions while maintaining airtight with the chamber. In some embodiments, the core 130 can have an overall shape with a circular cross-section normal to an axis around which the core 130 rotates. For example, the core 130 or at least part of the core 130 can be approximately in a sphere shape, a cylinder shape, an oval sphere shape, a cone shape, or a truncated cone shape, or a combination of two or more such shapes, or a combination of any of such shape with another shape. In some embodiments, the curved surface of the core 130 can cooperate with, e.g., an inner surface or a portion of the inner surface of the chamber, during the relative rotation between the core 130 and the shell assembly to assist in ensuring the air tightness.

As shown in FIGS. 1 and 5, the core 130 includes a material holder 140. The material holder 140 can be a member with, for example, one or more inclined surfaces, and can be configured to hold a piece of material (such as a sample) to be prepared and/or transferred. In some embodiments, the material holder 140 can include a separate structure fixed to a surface of the core 130. In the example shown in FIGS. 1 and 5, a first recess 133 is formed in the surface of the core 130 and is configured to accommodate the material holder 140. In some embodiments, the first recess 133 itself can function as the material holder 140. For example, the material can be held at the bottom of the first recess 133.

In some embodiments, the core 130 can be rotated relative to the shell assembly to expose the material holder 140 through the opening 111. In some embodiments, the core 130 can be rotated relative to the shell assembly to seal the material holder 140 in the chamber.

In some embodiments, as shown in FIGS. 1 and 5, the core 130 has a first planar surface 131, which can be connected to the curved surface of the core 130, and the material holder 140 is arranged at the first planar surface 131. In some embodiments, the first recess 133 for accommodating the material holder 140 or functioning as the material holder 140 can be formed in the first planar surface 131.

In the example shown in FIGS. 1 and 5, one material holder 140 is provided at the core 130. In some other embodiments, a plurality of material holders 140 can be provided at the core 130 such that a plurality of pieces of material can be prepared and/or transferred together. In some embodiments, the core 130 can also have a plurality of first planar surfaces each being provided with one of the plurality of material holders. In some embodiments, the material holders 140 can be in a one-to-one correspondence with the first planar surfaces 131.

As shown in FIG. 5, the core 130 further includes a second recess 134 configured to accommodate at least a portion of the rotation shaft 150, such as the connection member 151 of the rotation shaft 150. In some embodiments, the connection member 151 of the rotation shaft 150 can cooperate with an inner surface of the second recess 134 to realize the rotation of the core 130 as driven by the rotation shaft 150. For example, the connection member 151 and the second recess 134 can be shaped or configures in such a manner that a rotation of the rotation shaft 150 (and hence the connection member 151) can cause the core 130 to also rotate. In some embodiments, a cross-section of the connection member 151 along an axial direction of the rotation shaft 150 and a cross-section of the second recess 134 along a center axis thereof can have a same shape, such as a triangle or a rectangle shape, so that the connection member 151 can be tightly fixed to the second recess 134. In some other embodiments, such a cross-section of the connection member 151 and such cross-section of the second recess 134 can have different shapes, as long as the connection member 151 can cooperate with the second recess 134 to drive the rotation shaft 150 to rotate.

In some embodiments, as shown in FIG. 5, the core 130 further has a second planar surface 132, and the second recess 134 is formed at the second planar surface 132. The second planar surface 132 can increase a contact area between the core 130 and the inner surface of the shell assembly, such as the inner surface of the first shell 110, and hence improve the air tightness.

In some embodiments, the first planar surface 131 and the first recess 133 can share a first center axis, i.e., the center axis of the first planar surface 131 and the center axis of the first recess 133 can align with each other and both be the first center axis. The first center axis can pass through a center of the core 130. The second planar surface 132 and the second recess 134 can share a second center axis, i.e., the center axis of the second planar surface 132 and the center axis of the second recess 134 can align with each other and both be the second center axis. The second center axis can pass through the center of the core 130. In some embodiments, the first center axis can be approximately perpendicular to the second center axis. In some other embodiments, the first planar surface 131 and the first recess 133 can have different center axes, and the second planar surface 132 and the second recess 133 can have different center axes.

In some embodiments, the curved surface of the core 130 can cooperate with a peripheral edge of the opening 111 of the first shell 110 to seal the chamber of the shell assembly. The peripheral edge of the opening 111 can protrudes inwards from an inner surface of the first shell 110. Thus, when the core 130 rotates to cause the material at the material holder 140 to be in the chamber, the material transfer device 100 can be in a sealed mode, and the material can be protected from an outside environment. When the core 130 rotates to cause the material at the material holder to be exposed to the outside environment, the material transfer device 110 can be in an operation mode, and the material can be processed or analyzed. In some other embodiments, a sealing member can be arranged at the opening to further ensure the air-tightness of the chamber.

Further, as described above in connection with FIG. 4, in some embodiments, a sealed space is formed between the bottom surface of the second shell 120 and the core 130 by the seal member 160, the inner surface of the second shell 120, and the curved surface of the core 130. Such sealed space can serve as an additional sealed space. When the material at the material holder 140 is rotated into this additional sealed space, the material can be sealed and protected from an environment of the rest of the chamber of the shell assembly. In some embodiments, a plurality of sealing members can be arranged at the inner surface of the chamber to form a plurality of sealed spaces with the curved surface of the core 130. Therefore, the material transfer device 100 can satisfy different sealing requirements for the material.

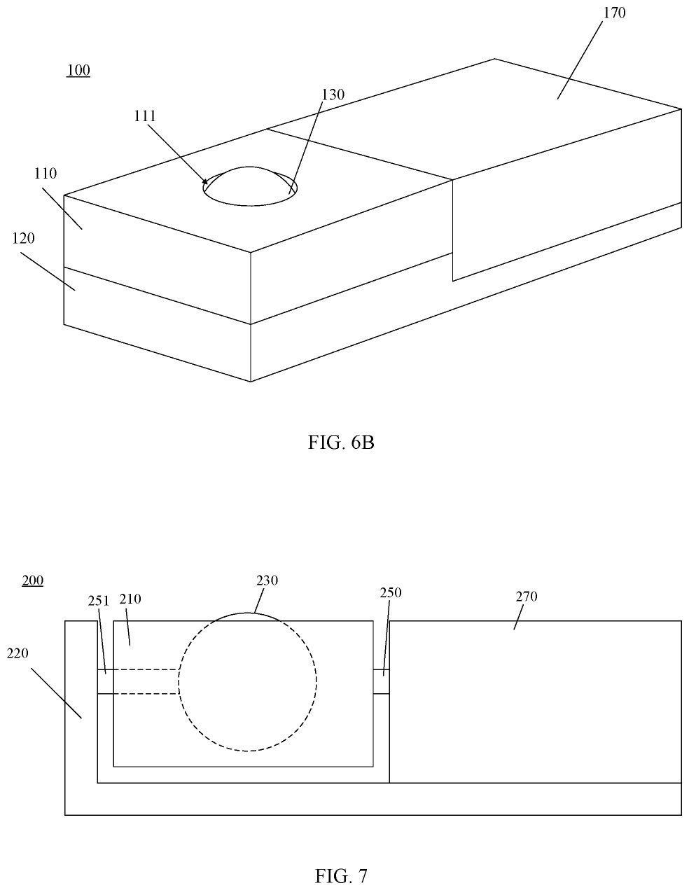

FIGS. 6A and 6B are schematic diagrams showing the material transfer device 100 in the operation mode and the sealed mode, respectively, according to an embodiment of the disclosure. As shown in FIGS. 6A and 6B, the material transfer device 100 further includes a drive mechanism 170. The drive mechanism 170 is configured to drive the rotation shaft 150 to rotate, so as to drive the core 130 to rotate. The drive mechanism 170 can include, for example, a motor.

In some embodiments, when the core 130 is rotated relative to the shell assembly to cause the material holder 140 to rotate into the chamber, the material holder 140 can be sealed in the chamber. Thus, any material arranged at the material holder 140 can be protected from the outside environment.

In the embodiments described above, the relative rotation between the core 130 and the shell assembly is achieved by rotating the core 130. In some other embodiments, the relative rotation can be achieved by rotating the shell assembly or both the core 130 and the shell assembly. FIG. 7 is a schematic diagram of another example material transfer device 200 with a rotatable shell assembly according to an embodiment of the disclosure. The material transfer device 200 includes a shell assembly 210, a body 220, a core 230, and a drive mechanism 270.

The body 220 includes a first wall and a second wall arranged at an angle relative to each other. In some embodiments, the first wall and the second wall can be perpendicular to each other to form an L-shaped structure.

The structures of the shell assembly 210 and the core 230 can be similar to those of the shell assembly and the core 130 described above in connection with FIGS. 1-6B. For example, the core 230 the shell assembly 210 can include a material holder and the shell assembly 210 can include a chamber and an opening. The chamber of the shell assembly 210 can at least partially accommodate the core 230. The material holder of the core 230 can be sealed in the chamber or be exposed through the opening of the shell assembly 210. The core 230 can also include a first recess configured to mount the material holder or function as the material holder.

As shown in FIG. 7, the material transfer device 200 further includes a fixation member 251 connecting the core 230 to the first wall of the body 220. The fixation member 251 can include, e.g., a rod. The fixation member 251 is configured to prevent the core 230 from rotating while the shell assembly 210 is rotating, e.g., keeping (fixing) the core 230 at a certain position while the shell assembly 210 is rotating.

In some embodiments, the shell assembly 210 can also include a through-hole, and the fixation member 251 can pass through the through-hole of the shell assembly 210, such that the shell assembly 210 can rotate around the fixation member 251. In some embodiments, a sealing member (such as an elastic ring, e.g., a rubber ring) can be arranged at least partially between the fixation member 251 and an inner surface of the through-hole, to prevent leakage from occurring through the space between the fixation member 251 and the inner surface of the through-hole.

In some embodiments, the fixation member 251 can be fixedly connected to the first wall of the body 220 and/or the core 230, e.g., by welding, using an adhesive material or screw(s), or via interference fit. For example, the core 230 can include a second recess and a part of the fixation member 251 (which can be, e.g., a connection member) can be inserted in the second recess and configured to cooperate with an inner surface of the second recess to fixedly connect the core 230 to the first wall of the body 220. In some embodiments, the fixation member 251 can be formed as an integral part with the first wall of the body 220 and/or the core 230.

In some embodiments, the fixation member 251 can be loosely connected to the first wall of the body 220 and/or the core 230. That is, the fixation member 251 is not fixed to the first wall of the body 220 and/or the core 230. For example, the second recess of the core 230 and the part of the fixation member 251 inserted in the second recess can be structured in such a manner that the fixation member 251 and the core 230 cannot rotate relative to each other but can relatively freely move relative to each other in a longitudinal direction of the fixation member 251.

As shown in FIG. 7, the material transfer device 200 further includes a rotation shaft 250 connecting the shell assembly 210 to the drive mechanism 270. The drive mechanism 270 can be configured to drive the rotation shaft 250 to rotate to cause the shell assembly 210 to rotate relative to the core 230, so as to expose the material holder through the opening or seal the material holder inside the chamber. The drive mechanism 270 can be fixed at the second wall of the body 220.

An axis of the fixation member 251 can pass through a center of the core 230. An axis of the rotation shaft 250 can coincide with the axis of the fixation member 251.

In the embodiments described above in connection with FIG. 7, the core 230 is connected to the first wall of the body 220 and the drive mechanism 270 is connected to the second wall of the body 220. In some other embodiments, the core 230 can be connected to the second wall or both the first wall and the second wall of the body 220, and the drive mechanism 270 can be connected to the first wall or both the first wall and the second wall of the body 220. In some embodiments, the body 220 can have only the second wall, which can, e.g., serve as a base to which both the core 230 and the drive mechanism 270 are connected (e.g., fixed). Any suitable arrangement and configuration of and among the shell assembly 210, the body 220, the core 230, and the drive mechanism 270 can be adopted, as long as such arrangement and configuration can allow the drive mechanism 270 to rotate the shell assembly 210 relative to the core 230.

In some embodiments, a material transfer device consistent with the disclosure (such as the example material transfer device 100 or 200 described above) can have a structure different from those described above, as long as the relative rotation between the core and the shell assembly can be realized.

In some embodiments, the material transfer device consistent with the disclosure can further include a controller. The controller can be an analog controller or a digital controller, and can be configured to control the operation of the material transfer device, such as controlling the drive mechanism to control the relative rotation between the core and the shell assembly. A wireless connection or a wired connection can be formed between the controller and other parts of the material transfer device.

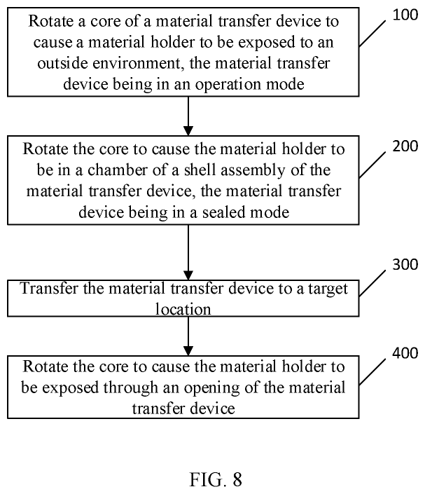

The present disclosure also provides a material transfer method. FIG. 8 is a schematic flowchart of the material transfer method according to an embodiment of the present disclosure. The material transfer method can be applied to the material transfer device 100 and will be described below in connection with FIGS. 6A, 6B, and 8. Similar method can be applied to the material transfer device 200 shown in FIG. 7, with rotating part being the shell assembly instead of the core.

As shown in FIG. 8, at S100, the core 130 is rotated to cause the material holder to be exposed to the outside environment. The material transfer device 100 is in the operation mode, as shown in FIG. 6A.

In some embodiments, the material transfer device 100 can be placed in a glovebox with a specific atmosphere (e.g., argon) desired by a user according to an application purpose. The material prepared in the glovebox can be protected from the air. After the core 130 is rotated to cause the material transfer device 100 to be in the operation mode, the material can be loaded to the material holder 140 at the core 130.

At S200, the core 130 is rotated to cause the material holder to be in the chamber of the shell assembly. The material transfer device 100 is in the sealed mode, as shown in FIG. 6.

In some embodiments, when the material transfer device 100 is in the sealed mode, the material can be protected in the protection environment. In some other embodiments, the core 130 can be rotated to cause the material to be in the additional sealed space between the bottom surface of the second shell 120 and the core 130. Thus, the material can be sealed in the sealed space for a specific purpose. For example, the material may need to be protected with an inert gas, such as Helium (He), Neon (Ne), and Argon (Ar). The inert gas can be filled in the additional sealed space. Thus, the material can be protected by the inert gas in the additional sealed space. In some other embodiments, other gases can be filled in the sealed space as needed.

In some embodiments, a plurality of sealing members can be arranged at the inner surface of the chamber. The plurality of sealing members can be configured to form a plurality of sealed spaces with the core 130 and the inner surface of the chamber. The plurality of sealed spaces can be filled with, e.g., different protection gases, or be in different levels of vacuum. Therefore, the material transfer device 100 can satisfy different sealing requirements for the material.

At S300, the material transfer device 100 in the sealed mode is transferred to a target location.

In some embodiments, the target location may be a chamber of a scanning electronic microscope (SEM). The following description is made by taking the target location as the chamber of the SEM as an example. After the material transfer device 100 is transferred into the chamber of the SEM, the chamber of the SEM can be pumped to a high level of vacuum to form a protection environment.

At S400, the core 130 is rotated to cause the material to be exposed through the opening. The material transfer device 100 is again in the operation mode shown in FIG. 6.

In some embodiments, after the core 130 is rotated to cause the material to be exposed through the opening, the material can be characterized and/or analyzed using the SEM. In some other embodiments, the core 130 can be rotated by different angles. Thus, the material can be tilted at different angles to meet different analysis needs. Since the material can be tilted at the material transfer device 100 for analysis, the material may not need to be taken off from the material holder 140 of the material transfer device 100. The material transfer device 100 can be configured to hold and tilt the material in the SEM, which simplifies the material analysis process.

Although the principles and implementations of the present disclosure are described by using specific embodiments in the specification, the foregoing descriptions of the embodiments are only intended to help understand the method and core idea of the method of the present disclosure. Meanwhile, a person of ordinary skill in the art may make modifications to the specific implementations and application range according to the idea of the present disclosure. In conclusion, the content of the specification should not be construed as a limitation to the present disclosure.

What is claimed is:

1. A material transfer device comprising:
a shell assembly having a chamber and an opening, the opening being in communication with the chamber; and
a core arranged in the chamber and including a material holder;
wherein the shell assembly and the core are configured to rotate relative to each other to seal the material holder inside the chamber or expose the material holder via the opening.

2. The device according to claim 1, further comprising:
a seal member arranged in the chamber and configured to form a sealed space with the shell assembly and the core.

3. The device according to claim 2, wherein:
the shell assembly and the core are configured to rotate relative to each other to cause the material holder to be sealed in the sealed space.

4. The device according to claim 1, further comprising:
a plurality of seal members arranged at an inner surface of the chamber to form a plurality of sealed spaces with the core, the core being rotated for an angle to cause the material holder to be sealed in one of the plurality of sealed spaces.

5. The device according to claim 1, wherein the shell assembly includes:
a first shell, a first chamber space being formed in the first shell; and
a second shell, a second chamber space being formed in the second shell, the first shell and the second shell being connected to form the chamber to rotatably accommodate the core in the chamber.

6. The device according to claim 5, wherein the first shell includes:
a flange extending outwards from a periphery of the first shell and abutting against the second shell;
a plurality of through-holes on the flange; and
a protrusion protruding from the flange along a periphery of the first chamber space and configured to cooperate with an inner surface of the second chamber space of the second shell to form a sealed connection between the first shell and the second shell.

7. The device according to claim 6, wherein the second shell includes:
a plurality of holes configured to form a threaded connection with the plurality of through-holes on the flange of the first shell, each of the plurality of holes corresponding to one of the plurality of through-holes on the flange.

8. The device according to claim 1, wherein:
the core has a curved surface and a planar surface connected to each other; and
a recess is formed on the planar surface and is configured to accommodate the material holder.

9. The device according to claim 8, further comprising:
a seal member arranged at the opening and configured to seal the chamber with the curved surface of the core.

10. The device according to claim 1,
wherein:
a recess is formed at the core;
the device further comprising:
a rotation shaft including a connection member inserted in the recess, the connection member being configured to cooperate with an inner surface of the recess to realize a rotation of the core as driven by the rotation shaft.

11. The device according to claim 10, wherein:
a cross-section of the recess along a center axis of the recess and a cross-section of the connection member along an axial direction of the rotation shaft have a same shape.

12. The device according to claim 10, wherein:
a cross-section of the recess along a center axis of the recess and a cross-section of the connection member along an axial direction of the rotation shaft have different shapes as long as the connection member cooperates with the recess to drive the core to rotate.

13. The device according to claim 10,
wherein the shell assembly includes a through-hole configured to allow the rotation shaft to pass through;
the device further comprising:
a drive mechanism configured to drive the rotation shaft to rotate.

14. The device according to claim 13, further comprising:
a seal member arranged at the through-hole to seal the chamber.

15. The device according to claim 1,
wherein:
a recess is formed at the core;
the device further comprising:
a body including a first wall and a second wall arranged at an angle relative to each other;
a fixation member connected to the first wall and partially inserted in the recess, and configured to cooperate with an inner surface of the recess to connect the core to the first wall; and
a rotation shaft connected to the shell assembly and configured to drive the shell assembly to rotate.

16. The device according to claim 1, wherein:
the core is configured to be rotated by different angles to expose the material holder through the opening.

17. A material transfer method comprising:
rotating a core of a material transfer device to cause a material holder to be exposed to an outside environment, the material transfer device being in an operation mode; rotating the core to cause the material holder to be in a chamber of a shell assembly of the material transfer device, the material transfer device being in a sealed mode;
transferring the material transfer device to a target location; and
rotating the core to cause the material holder to be exposed through an opening of the material transfer device.

18. The method according to claim 17, wherein the material transfer device includes:
the shell assembly having the chamber and the opening, the opening being in communication with the chamber; and
the core arranged in the chamber and including the material holder; and
a seal member arranged in the chamber and configured to form a sealed space with the shell assembly and the core.

19. The method according to claim 18, wherein rotating the core to cause the material holder to be in the chamber of the shell assembly of the material transfer device includes:
rotating the core relative to the shell assembly to cause the material holder to be sealed in the sealed space.

20. The method according to claim 17, wherein:
the material transfer device includes a plurality of seal members arranged at an inner surface of the chamber to form a plurality of sealed spaces with the core; and
rotating the core to cause the material holder to be in the chamber of the shell assembly of the material transfer device includes rotating the core for an angle to cause the material holder to be sealed in one of the plurality of sealed spaces.
